(19) United States
(12) Patent Application Publication
(10) Pub. No.: US 2023/0404304 A1
(43) Pub. Date: Dec. 21, 2023

(54) Pillow Speaker Device

(71) Applicants: Eric Orr, Chesapeake, VA (US); Karen Orr, Chesapeake, VA (US)

(72) Inventors: Eric Orr, Chesapeake, VA (US); Karen Orr, Chesapeake, VA (US)

(21) Appl. No.: 18/321,902

(22) Filed: May 23, 2023

Related U.S. Application Data
(60) Provisional application No. 63/351,455, filed on Jun. 13, 2022.

(51) Int. Cl. A47G 9/10; H04R 1/02; H04R 3/00; H04R 1/34

(52) U.S. Cl. CPC A47G 9/1045; H04R 1/028; H04R 3/00; A47G 2009/006; H04R 2420/07; A47G 2009/1018; H04R 1/342

(57) ABSTRACT

The present invention relates to a novel pillow speaker device. The device is a unique, comfortable pillow with a Bluetooth speaker that can be interchangeable by the user. The device comprises a pillow with a Bluetooth speaker. The speaker is paired with a mobile application or software that allows a user to control the device. Users can play music or desired sounds from the speaker to help him or her fall asleep comfortably.

### CROSS-REFERENCE TO RELATED APPLICATION

The present application claims priority to, and the benefit of, U.S. Provisional Application No. 63/351,455, which was filed on Jun. 13, 2022, and is incorporated herein by reference in its entirety.

### FIELD OF THE INVENTION

The present invention relates generally to the field of pillow speaker devices. More specifically, the present invention relates to an improved pillow speaker device that provides users with a pillow featuring an interchangeable Bluetooth speaker. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, this invention relates to improvements in pillows of the type which comprise a speaker. Generally, users may lack the means to get a good night's sleep for a variety of reasons, such as being distracted, being stressed out, being uncomfortable while laying down, etc. Without a good night's rest, users may wake up the next day exhausted and be unable to perform their daily tasks and routines.

Furthermore, some users have irregular work schedules, work night shift, or wake up early in the morning to go to work, preventing them from obtaining a full night's rest. Additionally, some users have difficulty sleeping throughout the night and may not feel well rested in the morning. As a result, users may feel tired throughout the day and may take a nap to compensate for the insufficient sleep during the previous night. Taking a nap allows the user to gain additional rest so as to have more energy for the remainder of the day.

The present invention provides a pillow with an integrated Bluetooth speaker. The pillow of the present invention comprises a pillow having a soft, cushioned body, and an interior cavity in which a Bluetooth speaker is contained. The pillow body is enclosed within a removable cover that protects the pillow body from spills and stains. The interior cavity houses the Bluetooth speaker and one or more batteries. The Bluetooth speaker may be wirelessly operated via an external electronic device, such as a cell phone or tablet computer. Thus, the user can remotely control the Bluetooth speaker using his or her cell phone, tablet computer, or other similar electronic device.

Therefore, there exists a long-felt need in the art for a pillow speaker device that provides users with an improved pillow featuring an interchangeable Bluetooth speaker. There is also a long-felt need in the art for a pillow speaker device that allows users to play music or ambient sounds from a smart phone application directly through the pillow. Further, there is a long-felt need in the art for a pillow speaker device that includes several different shapes, sizes, and configurations of the pillow to accommodate a user's needs and preferences. Moreover, there is a long-felt need in the art for a device that helps users get a good, peaceful night's rest to improve their overall health. Further, there is a long-felt need in the art for a pillow speaker device that comprises a speaker paired with a mobile application or software. Finally, there is a long-felt need in the art for a pillow speaker device that comprises an interchangeable Bluetooth speaker.

The subject matter disclosed and claimed herein, in one embodiment thereof, comprises a pillow speaker device. The device is a unique, comfortable pillow with a Bluetooth speaker that can be interchangeable by the user. The device comprises a pillow with a Bluetooth speaker. The speaker is paired with a mobile application or software that allows a user to control the device. Users can play music or desired sounds from the speaker to help him or her fall asleep comfortably. The pillow speaker device is available in several different sizes and configurations including, but not limited to, therapeutic and travel pillows.

In this manner, the pillow speaker device of the present invention accomplishes all of the foregoing objectives and provides users with a device that allows users to play music or ambient sounds from a smartphone application directly through the pillow. The device allows a user to get a good, peaceful night's rest to improve their overall health. The device features an interchangeable Bluetooth speaker.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pillow speaker device. The device is a unique, comfortable pillow with a Bluetooth speaker that can be interchangeable by the user. The speaker is paired with a mobile application or software that allows a user to control the device. Users can play music or desired sounds from the speaker to help him or her fall asleep comfortably.

In one embodiment, the pillow of the pillow speaker device is a soft, comfortable surface on which the user may rest his or her head. The pillow is preferably substantially rectangular but may have any of a variety of shapes and configurations including, but not limited to, therapeutic and travel pillows. The pillow is preferably composed of memory foam, but may be composed of other soft materials including cotton, polyester, or down, etc.

In one embodiment, it should be appreciated that the pillow is shown as having a cylindrical profile, however, the pillow may have any other suitable profile, such as a U-shaped profile or a more common rectangular profile. Further, the pillow includes an outer casing, having a main body portion, a first end portion and a second end portion. The outer casing may be made of any suitable stretchable or non-stretchable material, such as, for example, cotton, polyester, leather, or fabric, etc. The outer casing defines an inner chamber, which is partially filled with a fill material to provide the pillow with shape and fluffiness. The fill material may be, for example, poly-fil, cotton, down or foam, etc., and may be in any suitable form, such as, for example, beads or pellets.

Furthermore, the device comprises at least one speaker. If multiple speakers are used, the speakers are identical in construction: each including an exterior face for projecting sound outward from the speaker, and an opposing rear face for projecting sound into the inner chamber. Importantly, in one embodiment, the inner chamber of the pillow comprises a plurality of large interconnected, continuous sound channeling voids through which sound waves from the speakers can travel.

In one embodiment, a plurality of sound communication openings are provided through the inner chamber so that sounds, i.e., sound waves, can travel from the sound channeling voids through the inner chamber thereby reaching the user's head. A portion of the inner chamber extends downward to the sound baffles such that the sound channeling voids form the sound communication openings for the successful transmission of sounds. However, such sound communication openings could be formed in other ways. For example, holes or ducts (not illustrated) could be formed to extend between the inner chamber and the sound channeling voids.

In one embodiment, the speaker is of a type that is commonly available: wherein each speaker is of the type of construction that employs a cone which vibrates responsive to electromagnetic signals. With this type of construction, sound waves are emitted in front of the speaker, i.e., its exterior face, as well as to the rear through its rear face.

Importantly, a speaker disposed as noted above will produce sound waves that project rearward into the pillow as well as outward toward the user's head. In this way, sound from the speakers is directed toward and into the sound channeling voids wherein the sound waves travel through the sound channeling voids and through the communication openings to reach the user's head. In this way, sound waves reach the user's head from multiple directions. Accordingly, the quality of sound that is eventually heard by the user is enhanced.

In one embodiment, the pillow speaker device comprises a wireless chip as well as its related components and sensors that allows the speakers to pair and communicate with an external electronic mobile device or other smart device. Once paired, a user could control the speakers via the mobile application. In this embodiment, the user can operate the speakers using an associated external electronic device including, but not limited to, a smartphone, a tablet computer, or a laptop, etc.

In one embodiment, the wireless interface is also configured to receive signals (i.e., infrared signals) such that information can be transferred through the interface to the wireless circuitry in order to support programming functionality.

In one embodiment, the circuitry includes electronic means to control the transmit power of the wireless transmitter (i.e., an IR diode associated with interface) to prevent problems if there are two of the same devices in a room.

In one embodiment, the speaker is operated by a control panel disposed on the pillow. The buttons associated with the control panel are functionally connected to the circuitry. Circuitry is configured to communicate as necessary through an interface in order to execute user commands received through the buttons associated with the control panel.

In yet another embodiment, at least one pouch is disposed within the inner chamber adjacent to the first end portion of the pillow, adjacent to the second end portion of the pillow, or disposed between the first and second end portions. The pouch is made of any suitable material and is preferably made of the same material as that of the outer casing. The at least one pouch may be sewn on or otherwise attached to the inner chamber. As explained in further detail below, the at least one pouch provides pockets within the inner chamber that are not filled with the filler material.

As shown in one embodiment, at least one speaker is disposed within the at least one pouch. The speaker includes a sound-transmitting surface preferably facing the inside surface of the pillow.

In still further embodiments, the pillow may be constructed without pouches, so that the speaker is simply housed within the inner chamber. The speaker may be located at any location within the inner chamber.

In one embodiment, the speaker is retained within the inner chamber of the pillow via an adhesive.

In one embodiment, a pillowcase is illustrated. The pillowcase includes an opening encircled by a zipper. Accordingly, a speaker can be received into the pillowcase for protection, wherein the zipper can be employed to totally enclose the speaker. Further, it should be noted that the reinforced opening could be constructed using any commonly available plastic or metal grommet. As an alternate, the pillowcase is provided with an upper edge fastened with a typical hook and loop fastener, i.e., Velcro®.

In one embodiment, the pillow speaker device further comprises an alarm system disposed within the inner chamber thereof. The alarm system of the present invention comprises an alarm capable of generating a sound, a vibrating motor, and one or more speakers that are preferably positioned internally within said body of said pillow, wherein the components are operably connected by a control circuit. The speakers are positioned internally so that the speakers can be easily heard by a user having his or her head positioned on the pillow, but so that others in the vicinity of the user cannot easily hear the alarm. This helps to prevent the user from disturbing others when the alarm of the present invention sounds. Similarly, the vibrating motor is adapted to cause the body of the pillow to vibrate, silently waking the user without disturbing others in the nearby area.

The alarm system, as well as the speakers are battery operated and can be powered using one or more disposable or rechargeable batteries. The batteries can be inserted and removed from the pillow by means of a hinged lid disposed on the rear surface of the pillow that provides access to a battery compartment. In some embodiments, the hinged lid comprises a layer of padding or cushioning thereon, so that the user of the pillow does not feel the hinged lid on the exterior of the pillow.

In one embodiment, the alarm system is operated by a control panel disposed on the pillow. In such embodiments, the control panel comprises a display screen and one or more controls, such as switches or buttons, to set the time and the type of alarm. The control panel allows a user to input a specific time for the alarm to sound or allows the user to set a timer, such that the alarm sounds after a preset period of time. For example, the user can set the alarm to produce an alert after twenty minutes. This helps the user to nap for a particular period of time, which may be preferable to selecting the time at which the user will wake up. Further, the user can select the alert type and can choose to be woken by a beep, tone, music, vibrations, or a combination of these alerts. In this way, the control panel is attached to the pillow and allows a user to set an alarm and turn off the alarm once the user has woken up.

Furthermore, by using the software application, the user can easily control the speakers and/or alarm on the pillow of the present invention using his or her smartphone or similar device. Thus, in embodiments of the present invention having a wireless chip, the alarm system of the pillow can be remotely operated, obviating the need for a control panel to be disposed directly on the body of the pillow.

In yet another embodiment, the pillow speaker device comprises a plurality of indicia.

In yet another embodiment, a method of utilizing a pillow speaker device is described. The method includes the steps of providing a pillow speaker device comprising a comfortable pillow with a Bluetooth speaker. The method also comprises positioning the pillow in a desired position, such that a user can easily sleep on the pillow device. Further, the method comprises turning on the Bluetooth speaker via a mobile device. Finally, listening to music or desired sounds from the Bluetooth speaker to help a user fall asleep comfortably.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the pillow speaker device of the present invention in accordance with the disclosed architecture;

FIG. 2 illustrates a perspective view of one embodiment of the pillow speaker device of the present invention wherein the pillows are varying sizes in accordance with the disclosed architecture;

FIG. 3 illustrates a perspective view of one embodiment of the pillow speaker device of the present invention wherein the pillow is a memory foam orthopedic pillow in accordance with the disclosed architecture;

FIG. 4 illustrates a perspective view of one embodiment of the pillow speaker device of the present invention wherein the pillow is a travel pillow in accordance with the disclosed architecture;

FIG. 5 illustrates a block diagram of the wireless communication module in communication with a smart device and the pillow speaker device of the present invention in accordance with the disclosed architecture; and

FIG. 6 illustrates a flowchart showing the method of utilizing a pillow speaker device in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a pillow speaker device that provides users with an improved pillow featuring an interchangeable Bluetooth speaker. There is also a long-felt need in the art for a pillow speaker device that allows users to play music or ambient sounds from a smart phone application directly through the pillow. Further, there is a long-felt need in the art for a pillow speaker device that includes several different shapes, sizes, and configurations of the pillow to accommodate a user's needs and preferences. Moreover, there is a long-felt need in the art for a device that helps users get a good, peaceful night's rest to improve their overall health. Further, there is a long-felt need in the art for a pillow speaker device that comprises a speaker paired with a mobile application or software. Finally, there is a long-felt need in the art for a pillow speaker device that comprises an interchangeable Bluetooth speaker.

The present invention, in one exemplary embodiment, is a novel pillow speaker device. The device is a unique, comfortable pillow with a Bluetooth speaker that can be interchangeable by the user. The speaker is paired with a mobile application or software that allows a user to control the device. Users can play music or desired sounds from the speaker to help him or her fall asleep comfortably. The pillow speaker device is available in several different sizes and configurations including, but not limited to, therapeutic and travel pillows. The present invention also includes a novel method of utilizing a pillow speaker device. The method includes the steps of providing a pillow speaker device comprising a comfortable pillow with a Bluetooth speaker. The method also comprises positioning the pillow in a desired position, such that a user can easily sleep on the pillow device. Further, the method comprises turning on the Bluetooth speaker via a mobile device. Finally, listening to music or desired sounds from the Bluetooth speaker to help a user fall asleep comfortably.

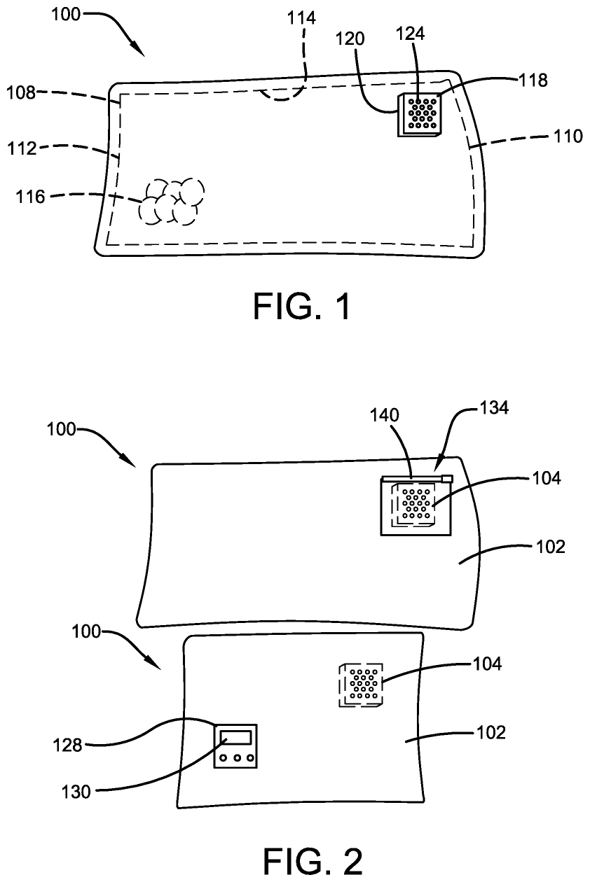

Referring initially to the drawings, FIGS. 1-4 illustrate a perspective view of one embodiment of the pillow speaker device 100 of the present invention. In the present embodiment, the pillow speaker device 100 is an improved pillow speaker device that plays music or desired sounds from the Bluetooth speaker to help a user fall asleep. The device 100 is especially designed to allow any suitable user as is known in the art, to easily and comfortably fall asleep. More specifically, the device 100 comprises a unique, comfortable pillow 102 with a Bluetooth speaker 104 that can be interchangeable by the user.

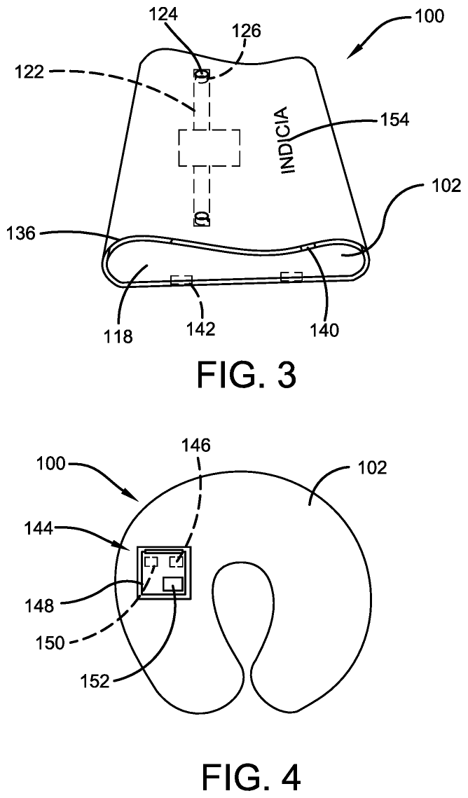

In one embodiment, the pillow 102 of the pillow speaker device 100 is a soft, comfortable surface on which the user may rest his or her head (not shown). The pillow 102 is preferably substantially rectangular (as shown in FIG. 1) but may have any of a variety of shapes and configurations (as shown in FIG. 2) including, but not limited to, therapeutic or memory foam orthopedic pillows (as shown in FIG. 3) and travel pillows (as shown in FIG. 4). Additionally, the pillow 102 is preferably composed of memory foam, but may be composed of other soft materials including cotton, polyester, or down, etc.

In one embodiment, it should be appreciated that the pillow 102 is shown as having a cylindrical profile (as shown in FIG. 2), however, the pillow 102 may have any other suitable profile, such as a U-shaped profile (as shown in FIG. 4) or a more common rectangular profile (as shown in FIG. 1). Further, the pillow 102 includes an outer casing 106, having a main body portion 108, a first end portion 110 and a second end portion 112. The outer casing 106 may be made of any suitable stretchable or non-stretchable material, such as, for example, cotton, polyester, leather, or fabric, etc. The outer casing 106 defines an inner chamber 114, which is partially filled with a fill material 116 to provide the pillow 102 with shape and fluffiness. The fill material 116 may be, for example, poly-fil, cotton, down or foam, etc., and may be in any suitable form, such as, for example, beads or pellets, etc.

Furthermore, the device 100 comprises at least one speaker 104. If multiple speakers 104 are used, the speakers 104 are identical in construction: each including an exterior face 118 for projecting sound outward from the speaker 104, and an opposing rear face 120 for projecting sound into the inner chamber 114. Importantly, in one embodiment, the inner chamber 114 of the pillow 102 comprises a plurality of large interconnected, continuous sound channeling voids 122 through which sound waves from the speakers 104 can travel.

In another embodiment, a plurality of sound communication openings 124 are provided through the inner chamber 114 so that sounds, i.e., sound waves, can travel from the sound channeling voids 122 through the inner chamber 114 thereby reaching the user's head. A portion of the inner chamber 114 extends downward to the sound baffles 126 such that the sound channeling voids 122 form the sound communication openings 124 for the successful transmission of the sounds. However, such sound communication openings 124 could be formed in other ways. For example, holes or ducts (not shown) could be formed to extend between the inner chamber 114 and the sound channeling voids 122.

In one embodiment, the speaker 104 is of a type that is commonly available: wherein each speaker 104 is of the type of construction that employs a cone which vibrates responsive to electromagnetic signals. With this type of construction, sound waves are emitted in front of the speaker 104, i.e., its exterior face 118, as well as to the rear through its rear face 120.

Importantly, a speaker 104 disposed as noted above will produce sound waves that project rearward into the pillow 102 as well as outward toward the user's head. In this way, sound from the speakers 104 is directed toward and into the sound channeling voids 122 wherein the sound waves travel through the sound channeling voids 122 and through the communication openings 124 to reach the user's head. In this way, sound waves reach the user's head from multiple directions. Accordingly, the quality of sound that is eventually heard by the user is enhanced.

In one embodiment, the speaker 104 is operated by a control panel 128 disposed on the pillow 102. The buttons 130 associated with the control panel 128 are functionally connected to the circuitry. The circuitry is configured to communicate as necessary through an interface in order to execute user commands received through the buttons 130 associated with the control panel 128.

In yet another embodiment, at least one pouch 132 is disposed within the inner chamber 114 adjacent to the first end portion 110 of the pillow 102, adjacent to the second end portion 112 of the pillow 102 or disposed between the first and second end portions 110, 112. The pouch 132 is made of any suitable material and is preferably made of the same material as that of the outer casing 106. The at least one pouch 132 may be sewn on or otherwise attached to the inner chamber 114. As explained in further detail below, the at least one pouch 132 provides pockets within the inner chamber 114 that are not filled with the filler material 116.

Further, at least one speaker 104 is disposed within the at least one pouch 132. The speaker 104 includes a sound-transmitting surface 134 preferably facing the inner chamber 114 of the pillow 102.

In still further embodiments, the pillow 102 may be constructed without pouches 132, so that the speaker 104 is simply housed within the inner chamber 114. The speaker 104 may be located at any location within the inner chamber 114. In this embodiment, the speaker 104 is retained within the inner chamber 114 of the pillow 102 via an adhesive, hook and loop fasteners, or any other suitable securing means as is known in the art, depending on the needs and/or wants of a user.

In one embodiment, a pillowcase 136 is illustrated. The pillowcase 136 includes an opening 138 encircled by a zipper 140. Accordingly, a speaker 104 can be received into the pillowcase 136 for protection, wherein the zipper 140 can be employed to totally enclose the speaker 104. Further, it should be noted that the reinforced opening 138 could be constructed using any commonly available plastic or metal grommet (not shown). As an alternative, the pillowcase 136 is provided with an upper edge fastened with a typical hook and loop fastener 142, i.e., Velcro®.

In one embodiment, the pillow speaker device 100 further comprises an alarm system 144 disposed within the inner chamber 114 thereof. The alarm system 144 of the present invention comprises an alarm capable of generating a sound, a vibrating motor 146, and one or more speakers 104 that are preferably positioned internally within said body of said pillow 102, wherein the components are operably connected by a control circuit (not shown). The speakers 104 are positioned internally so that the speakers 104 can be easily heard by a user having his or her head positioned on the pillow 102, but so that others in the vicinity of the user cannot easily hear the alarm. This helps to prevent the user from disturbing others when the alarm of the present invention sounds. Similarly, the vibrating motor 146 is adapted to cause the body of the pillow 102 to vibrate, silently waking the user without disturbing others in the nearby area.

The alarm system 144, as well as the speakers 104 are battery operated and can be powered using one or more disposable or rechargeable batteries 146. The batteries 146 can be inserted and removed from the pillow 102 by means of a hinged lid 148 disposed on the rear surface of the pillow 102 that provides access to a battery compartment 150. In some embodiments, the hinged lid 148 comprises a layer of padding or cushioning thereon, so that the user of the pillow 102 does not feel the hinged lid 148 on the exterior of the pillow 102.

In one embodiment, the alarm system 144 is operated by a control panel 128 disposed on the pillow 102. In such embodiments, the control panel 128 comprises a display screen 152 and one or more controls, such as switches or buttons 130, to set the time and the type of alarm. The control panel 128 allows a user to input a specific time for the alarm to sound or allows the user to set a timer, such that the alarm sounds after a preset period of time. For example, the user can set the alarm to produce an alert after twenty minutes. This helps the user to nap for a particular period of time, which may be preferable to selecting the time at which the user will wake up. Further, the user can select the alert type and can choose to be woken by a beep, r tone, music, vibrations, or a combination of these alerts. In this way, the control panel 128 is attached to the pillow 102 and allows a user to set an alarm and turn off the alarm once the user has woken up.

In yet another embodiment, the pillow speaker device 100 comprises a plurality of indicia 154. The pillow speaker device 100 may include advertising, a trademark, or other letters, designs, or characters, printed, painted, stamped, or integrated into the speakers 104, or any other indicia 154 as is known in the art. Specifically, any suitable indicia 154 as is known in the art can be included, such as, but not limited to, patterns, logos, emblems, images, symbols, designs, letters, words, characters, animals, advertisements, brands, etc., that may or may not be sleep or pillow/brand related.

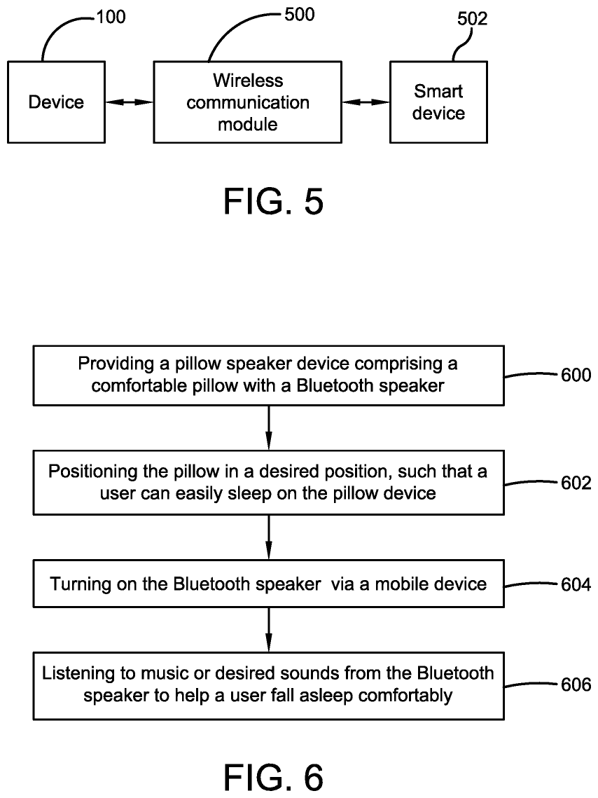

FIG. 5 illustrates a block diagram of the wireless communication module 500 in communication with a smart device 502 and the pillow speaker device 100 of the present invention. The pillow speaker device 100 includes a wireless communications module 500 and additional sensors which would allow the device 100 to pair with a mobile application on a smart device 502. Once paired, a user could control the pillow speaker device 100 via the mobile application. In this embodiment, the user can operate the speakers 104 using an associated external electronic device 502, including but not limited to, a smartphone, a tablet computer, or a laptop, etc., or any other suitable electronic devices as is known in the art.

The present disclosure connects to the user's smartphone 502 via BLE (Bluetooth low energy) and allows the user to control the speakers 104 via their smartphone 502. When the mobile application is launched on the smartphone 502, the user has to select the device 100 that they want to connect to (in case they have multiple speakers 104) and pair to it. After the phone 502 pairs, the user can control the speakers 104 via buttons on the mobile application. When one of the buttons is pressed in the mobile application, a command is sent to a controller which causes the speakers 104 to activate.

In one embodiment, the wireless interface 500 is also configured to receive signals (i.e., infrared signals) such that information can be transferred through the interface 500 to the wireless circuitry in order to support programming functionality.

Furthermore, by using a software application, the user can easily control the speakers 104 and/or alarm system 144 on the pillow 102 of the present invention using his or her smartphone or similar device 502. Thus, in embodiments of the present invention having a wireless chip 500, the alarm system 144 of the pillow 102 can be remotely operated, obviating the need for a control panel 128 to be disposed directly on the body of the pillow 102.

In another embodiment, the circuitry includes electronic means to control the transmit power of the wireless transmitter 500 (i.e., an IR diode associated with interface) to prevent problems if there are two of the same devices 100 in a room.

FIG. 6 illustrates a flowchart of the method of utilizing a pillow speaker device. The method includes the steps of at 600, providing a pillow speaker device comprising a comfortable pillow with a Bluetooth speaker. The method also comprises at 602, positioning the pillow in a desired position, such that a user can easily sleep on the pillow device. Further, the method comprises at 604, turning on the Bluetooth speaker via a mobile device, wherein the speaker is paired to the mobile device. The speaker is paired to the mobile device via a wireless communication module, as well as a mobile application. Finally, at 606, listening to music or desired sounds from the Bluetooth speaker to help a user fall asleep comfortably. A user is able to control the speaker via the mobile device.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “pillow speaker device”, “pillow device”, and “device” are interchangeable and refer to the pillow speaker device 100 of the present invention.

Notwithstanding the foregoing, the pillow speaker device 100 of the present invention can be of any suitable size and configuration as is known in the art without affecting the overall concept of the invention, provided that it accomplishes the above-stated objectives. One of ordinary skill in the art will appreciate that the pillow speaker device 100 as shown in FIGS. 1-6 are for illustrative purposes only, and that many other sizes and shapes of the pillow speaker device 100 are well within the scope of the present disclosure. Although the dimensions of the pillow speaker device 100 are important design parameters for user convenience, the pillow speaker device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pillow speaker device that plays music or desired sounds from a Bluetooth speaker to help a user fall asleep, the pillow speaker device comprising:
a pillow; and
at least one Bluetooth speaker;
wherein the at least one Bluetooth speaker is interchangeable by the user;
wherein an inner chamber of the pillow comprises a plurality of large interconnected, continuous sound channeling voids through which sound waves from the at least one Bluetooth speaker can travel; and
further wherein a plurality of sound communication openings are provided through the inner chamber so that sound waves, can travel from the plurality of large interconnected, continuous sound channeling voids through the inner chamber thereby reaching a head of the user.

2. The pillow speaker device of claim 1, wherein the pillow is substantially rectangle in shape.

3. The pillow speaker device of claim 1, wherein the pillow is a memory foam orthopedic pillow.

4. The pillow speaker device of claim 1, wherein the pillow is a travel pillow.

5. The pillow speaker device of claim 1, wherein the pillow comprises an outer casing, a main body portion, a first end portion, and a second end portion.

6. The pillow speaker device of claim 5, wherein the outer casing defines the inner chamber which is partially filled with a fill material.

7. The pillow speaker device of claim 1, wherein the at least one Bluetooth speaker comprises an exterior face and an opposing rear face for emitting sound waves.

8. The pillow speaker device of claim 1, wherein the at least one Bluetooth speaker is operated by a control panel disposed on the pillow.

9. The pillow speaker device of claim 1, wherein the at least one Bluetooth speaker comprises a wireless communications module that is configured to pair with a mobile application on a smart device.

10. The pillow speaker device of claim 1, wherein at least one pouch is disposed within the inner chamber for retaining the at least one Bluetooth speaker.

11. The pillow speaker device of claim 1, wherein the pillow comprises a pillowcase including an opening and zipper for securing the pillowcase on the pillow.

12. The pillow speaker device of claim 1 further comprising an alarm system disposed within the inner chamber for generating a sound to wake a user.

13. The pillow speaker device of claim 12, wherein the alarm system comprises a vibrating motor in communication with the at least one Bluetooth speaker, allowing the pillow to vibrate, silently waking the user.

14. The pillow speaker device of claim 13, wherein the alarm system and the at least one Bluetooth speaker are battery operated via rechargeable batteries.

15. A pillow speaker device that plays music or desired sounds from a Bluetooth speaker to help a user fall asleep, the pillow speaker device comprising:
a pillow comprising an outer casing, having a main body portion, a first end portion, and a second end portion, wherein the outer casing defines an inner chamber which is partially filled with a fill material; and
at least one Bluetooth speaker comprising an exterior face and an opposing rear face for emitting sound waves;
wherein the at least one Bluetooth speaker includes a wireless communications module which would allow the pillow speaker device to pair with a mobile application on a smart device;
wherein the inner chamber of the pillow comprises a plurality of large interconnected, continuous sound channeling voids through which sound waves from the at least one Bluetooth speaker can travel; and
wherein a plurality of sound communication openings are provided through the inner chamber so that sound waves, can travel from the plurality of large interconnected, continuous sound channeling voids through the inner chamber thereby reaching a user's head; and
further wherein the at least one Bluetooth speaker is battery operated via rechargeable batteries.

16. The pillow speaker device of claim 15 further comprising a plurality of indicia.

17. The pillow speaker device of claim 15 further comprising an alarm system disposed within the inner chamber for generating a sound to wake a user.

18. The pillow speaker device of claim 15, wherein at least one pouch is disposed within the inner chamber for retaining the at least one Bluetooth speaker.

19. The pillow speaker device of claim 15, wherein the at least one Bluetooth speaker is operated by a control panel disposed on the pillow.

20. A method of utilizing a pillow speaker device comprising the steps of:
providing a pillow speaker device comprising a comfortable pillow with a Bluetooth speaker;
positioning the pillow in a desired position, such that a user can easily sleep on the pillow device;
turning on the Bluetooth speaker via a mobile device; and
listening to music or desired sounds from the Bluetooth speaker to help a user fall asleep comfortably.
